(19) United States
(12) Patent Application Publication
(10) Pub. No.: US 2007/0023245 A1
(43) Pub. Date: Feb. 1, 2007

(54) PRESSURIZED MAGNETORHEOLOGICAL FLUID DAMPERS

(75) Inventors: Yiu Kee Lau, Hong Kong (CN); Wei Hsin Liao, Hong Kong (CN)

Correspondence Address: DARBY & DARBY P.C., P. O. BOX 5257, NEW YORK, NY, 10150-5257, US

(73) Assignee: The Chinese University of Hong Kong, Hong Kong (CN)

(21) Appl. No.: 11/460,728

(22) Filed: Jul. 28, 2006

Related U.S. Application Data
(60) Provisional application No. 60/703,428, filed on Jul. 29, 2005.

(51) Int. Cl. F16F 9/53

(52) U.S. Cl. 188/267.2; 188/312

(57) ABSTRACT

A magnetorheological (MR) fluid device including a pressurized MR liquid with an improved performance is provided. Also provided is a method for minimizing cavitation of a common magnetorheological device, comprising providing an MR fluid within the device with a pressure of at least 100 psi. The device as provided minimizes cavitation in the device, and can be broadly used in the railway vehicle suspension system with excellent performance.

This application claims the benefit of U.S. provisional patent application No. 60/703,428 filed on Jul. 29, 2005 which is explicitly incorporated by reference in its entirety.

### BACKGROUND OF THE INVENTION

1. Field of the Invention

This invention relates to a magnetorheological (MR) fluid device, and more particularly to a magnetorheological (MR) fluid damper having a pressurized MR fluid.

2. Description of Prior Art

Magnetorheological fluid devices that employ an MR fluid as the working medium to create controllable viscous damping forces are quite promising for vibration reduction applications. Compared to the conventional semi-active device such as variable orifice dampers, MR fluid dampers are fast responding and have less moving parts (only the piston assembly), which makes them simple and reliable.

The good adaptability of MR devices also provides them with novel applications in promising flexibility. A variety of MR devices have been developed for different applications, such as MR rotary devices used in exercise equipments, clutches and brakes; and linear MR devices used in suspension systems of automobiles or railway vehicles.

MR fluids commonly used in an MR device are one kind of controllable fluids that are able to reversibly change from a viscous liquid to a semi-solid (rheological change) with a controllable yield strength in milliseconds when exposed to a magnetic field. A common MR fluid comprises three major components: dispersed ferromagnetic particles, a carrier liquid and a stabilizer. When no magnetic field is applied (off-state), the MR fluid flows freely like a common liquid. When a sufficient strength of a magnetic field is applied (on-state), the ferromagnetic particles acquire dipole moments aligned along with the direction of the magnetic field to form linear chains parallel to the applied field. Consequently, this phenomenon solidifies the MR fluid to result in an increase of the MR fluid yield strength and restricts the movement of the MR fluid. The yield strength of the fluid increases as the strength of the applied magnetic field increases. Once the applied magnetic field is removed, the MR fluid goes back to the freely flowing liquid again within milliseconds.

A common MR damper may include a piston assembly with a piston rod sliding in an interior portion of a closed damper body that is fully filled with MR fluids. The piston rod has at least one end attached to the piston assembly within the damper body and has at least one end outside the damper body.

The damper body and at least one end of the piston rod are attached to separate structures in order to provide a damping force along the direction of the piston rod according to the relative motion between these two separate structures. When the piston is displaced, the MR fluids are forced to move from a compression chamber to an expansion chamber in the MR damper via an orifice. Then, the MR fluids inside the orifice are exposed to an applied magnetic field with different magnitudes upon applications. The magnetic field is generated by an electromagnetic circuit that is commonly located at a staging area of the piston core.

U.S. Pat. Nos. 5,277,281 and 5,878,851 to Carlson et al. and U.S. Pat. No. 6,427,813 to Carlson disclose different MR damper designs.

However, the MR fluid damper suffers from force lag phenomenon. Force lag phenomenon is, firstly, due to air pockets that are trapped inside the MR damper during the MR fluid-filling process. Secondly, it is due to the relatively high viscosity of the MR fluids. Both of these two factors will cause cavitation during the damper operation and degrade the performance of the MR damper. It would, therefore, be desirable to provide an MR fluid damper with the minimum cavitation.

Carlson's patent (U.S. Pat. No. 6,427,813) discloses an MR damper with an accumulator which includes an external compensator chamber for expansion and extraction of an MR liquid and a gas charge chamber. Though Carlson mentions that the accumulator can pressurize the MR liquid such that any cavitation is minimized, Calson keeps silent to how to minimize cavitation.

The references cited herein are explicitly incorporated by reference in its entirety.

### SUMMARY OF THE INVENTION

In order to overcome the above problems in the prior art, the present invention provides a magnetorheological fluid device which comprises a pressurized MR liquid at least 100 psi.

One aspect of the present invention is to provide a magnetorheological fluid device, comprising:

a) a housing including a hollow;

b) a moving mechanism within the hollow, the housing and the moving mechanism positioned to define at least one working portion and at least one chamber within the hollow;

c) a magnetorheological fluid within the at least one working portion and the at least one chamber, which has a pressure at least 100 psi; and

d) means for generating a magnetic field to act upon the MR fluid within the working portion to cause a rheology change therein.

Another aspect of the present invention is directed to a method for minimizing cavitation of a magnetorheological device which comprises providing an MR fluid within the device with a pressure at least 100 psi.

Still another aspect of the present invention is to provide a suspension system of a railway vehicle comprising at least one magnetorheological damper defined according to the present invention between a truck and a car body of the railway vehicle.

In an example embodiment of the invention, the MR fluid has a pressure between 100 psi and 400 psi. In another example embodiment, the MR fluid has a pressure between 100 psi and 200 psi.

The MR device as provided in the present invention has an improved performance because it can significantly minimize cavitation compared to those in the art. While applied to in a railway vehicle system, it may increase the damping force at the lower sway mode without degrading the performance of the railway vehicle at the higher frequency upper sway mode. Furthermore, the device according to the invention can cope with various vibration motions under different situations.

### BRIEF DESCRIPTION OF THE DRAWINGS

The foregoing features and other advantages of the invention will be better understood from the accompanying drawings together with a description thereof given below, which serve to illustrate example embodiments of the invention. In the drawings,

FIG. 1 illustrates a partial cross-sectional side view of an MR damper according to the present invention;

FIG. 2 is a graph that shows the effect of force-lag phenomenon under different pressurized MR fluids; and

FIGS. 3-5 are a bottom view, a side view and a front view of a schematic railway vehicle utilizing MR fluid dampers of the invention, respectively.

### DETAILED DESCRIPTION OF THE INVENTION

Now referring to the drawings, in which like reference numerals represent like elements throughout, some example embodiments of the invention are illustrated.

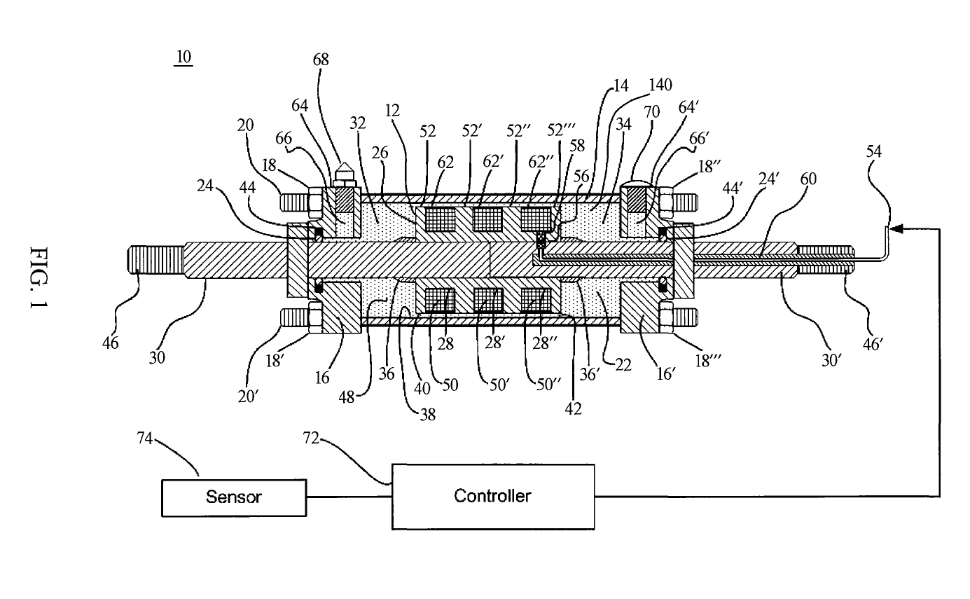

An MR device 10, particularly an MR damper, according to an example embodiment of the present invention is shown in FIG. 1.

The MR damper 10 includes a housing or body 14 which is normally made from a magnetically-soft material, such as low-carbon steel. In this embodiment, the housing 14 provides a cylindrical hollow 140.

The housing 14 is closed by two covers 16 and 16′ at its two ends, which are tied by tie rod nuts 18, 18′, 18″ and 18′″ on tie rods 20 and 20′ (in this embodiment, there being 8 rod nuts and 4 tie rods in total that are not fully shown in FIG. 1). They are assembled together to form a partially closed compartment.

Two circular apertures 24 and 24′ are formed at the center of the rod covers 16 and 16′, respectively. The apertures 24 and 24′ respectively receive two piston rods 30 and 30′ which are axially slidable. The apertures 24 and 24′ preferably include two bearings and seals 44 and 44′, which allow the piton rods to axially move and prevent escape of fluids inside from the compartment 22.

A piston assembly 12 is provided to embrace the two piston rods to axially slide synchronously with the piston rods within the housing 14. The piston assembly 12 comprises a piston head sleeve 26, which is attached to the two piston rods 30 and 30′ by means of screws or welding.

In an example embodiment of the present invention, the piston rods 30 and 30′ have the same diameter, which are axially extended out of the housing 14.

Since there is no change in volume within the closed interior compartment 22 as the piston rods move, this arrangement has an advantage that a rod-volume compensator, accumulator or other similar devices are not needed to be incorporated into the damper.

The piston head sleeve 26 is preferably manufactured by a magnetically-soft material with at least one spool and three spools 28, 28′ and 28″ in this embodiment. Having a separate piston head sleeve 26 attached to the piston rods 30 and 30′ to form the piston assembly 12 allows a more expensive whole piece piston assembly to be replaced. It also allows a simple and cost-effective way of modifying a conventional piston damper to an MR damper while reducing complexity and problems of center alignment, which will be described in detail later. In addition, it has a particularly simple geometry in which the outer cylindrical housing is a part of the magnetic circuit.

The piston assembly 12 divides the compartment 22 into a first fluid chamber 32 and a second fluid chamber 34.

In the invention, cushion rings 36 and 36′ are provided, which are attached to the two piston rods 30 and 30′ and axially extended along the piston rods from the piston head sleeve 26 respectively. The cushion rings are configured in such a shape that hydromechanically provides a smoother movement and reduces the resistance between the piston assembly 12 and the MR fluid 48 caused by the relatively high viscosity of the fluid during damper operation.

A gap between the inner wall (diameter) 38 of the cylindrical housing and the outer diameter 40 of the piston sleeve 26 forms a working portion, a fluid orifice 42.

Each piston rod 30 or 30′ has a threaded rod end 46 or 46′, respectively. A first structure that needs a vibration control is attached to at least one end of the piston rods 30 and 30′ by means of welding or fastening of at least one of threaded rod ends 46 and 46′. A second structure related to the first structure is attached to the MR damper housing or body 14 by means of welding of the covers 16 and 16′ or fastening the tie rod 20 or 20′.

When the piston rods 30 and 30′ are displaced (says from right to left in FIG. 1) due to a vibration-induced movement from the structure that is attached to the MR damper body 14. Then the MR fluid 48 is forced to flow from a compression chamber (the first fluid chamber 32) to an expansion chamber (the second fluid chamber 34) through the annular fluid orifice 42.

A magnetic field is generated when an electric current is applied to the preferably three spools of wound coils 50, 50′ and 50″, then a yield strength of the MR fluid 48 is increased in response to the magnetic field generated. The flow of the MR fluid 48 between the fluid chambers 32 and 34 can be controlled by the magnitude of the induced magnetic field via modulation of the electrical current applied to the wound coils 50, 50′ and 50″. In this way, the desired damping rate of the MR damper 10 is modulated so as to reduce the vibration of the attached structures.

Spaces between pole pieces 52, 52′, 52″ and 52′″ and the inner diameter 38 of the cylindrical body 14 form an active fluid region where the MR fluid 48 is being polarized. In this example embodiment of the present invention, the wound coils 50, 50′ and 50″ are wrapped in an alternate fashion in order to minimize inductance and allow an addictive magnetic field at the pole pieces 52′ and 52″. Electrical wires 54 that are connected to the wound coils 50, 50′ and 50″ are preferably sealed by using a hermetic seal 56 that is placed in a pilot hole 58. Then the electrical wires 54 exit from the piston head sleeve 26 via a wire tunnel 60 to the threaded rod end 46′. Epoxy-resin pastes 62, 62′ and 62″ are coated on the outer diameter of the wound coils 50, 50′ and 50″ in order to avoid the direct contact of the wound coils 50, 50′ and 50″ with the MR fluid 48 to prevent them from being worn and short-circuited.

Referring to FIG. 1, one or more sensors 74 are arranged at the above structure to collect signals which are transmitted to a controller 72 which controls a current to be applied to the wires 54. The controller 72 can be any of those in the art.

Now referring again to FIG. 1, during the on-state of MR fluid damper 10, the MR fluid 48 will be polarized to a high yield stress level by the high magnetic field induced through the electromagnetic circuit, so that it acts like a plug at the fluid orifice 42 between the two fluid chambers 32 and 34, which are divided by the piston assembly 12. As a result, the MR fluid in the annular fluid orifice 42 acts like an O-ring seal and slides with the piston assembly 12 in a direction of the inner diameter of the cylindrical housing 14, not allowing any fluid to pass from the compression chamber to the expansion chamber through the fluid orifice 42 during the damper operation cycle and vice versa. This situation causes cavitation in the expansion chamber and then initiates the force-lag phenomenon of the MR damper.

Due to the relatively high viscosity of the MR fluid, it is very difficult to eliminate all the air pockets and dissolved air therein, even though special care is taken to do so in the art.

The inventors have developed an inventive method and device using an appropriate pressure of the MR liquid to obviate the above drawbacks.

The inventors have determined that a successful solution is to increase the pressure of the MR fluid in the closed interior compartment 22 so as to reduce the effect of the trapped air and overcome the seal plug effect due to the relatively high yield stress of the MR fluid 48.

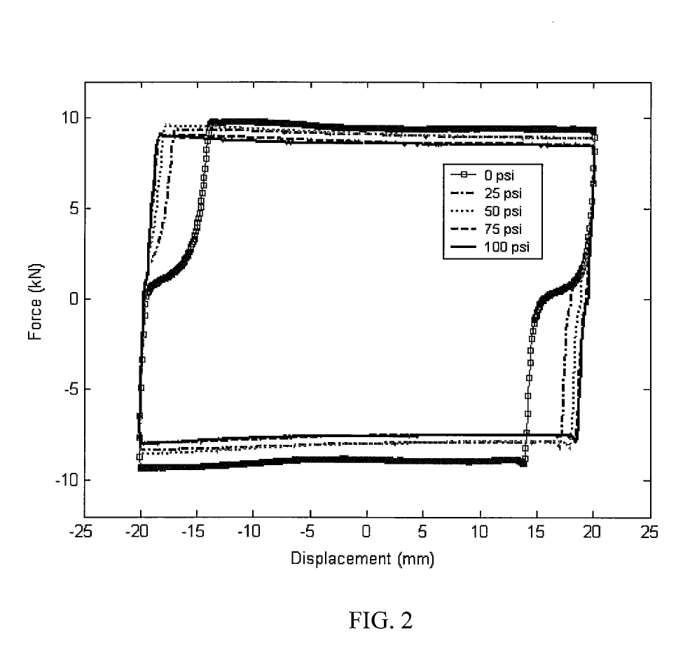

The inventors have conducted experiments to identify the effect of force-lag phenomenon against pressures of the MR fluid in the device. An MR damper with different pressurized fluids according to the invention is tested under a 20 mm, 0.1 Hz triangular displacement excitation with operation current at 1.5 A. The result is shown in FIG. 2.

Referring to FIG. 2, which shows the effect of pressurized MR fluids at 0, 25, 50, 75 and 100 psi on the force-lag phenomenon, it can be seen that the force-lag phenomenon can be reduced as the MR fluid pressure is increased. When the pressure of the MR fluid within the damper is raised to 100 psi, the force-lag phenomenon is nearly eliminated.

It is expected that the performance of the MR damper will be fine where the MR fluid keeps a pressure from 100 psi to 400 psi, preferably from 100 psi to 200 psi.

The inventors have also discovered that in order to prevent the force-lag phenomenon of the MR damper 10, special care is needed in filling of the MR fluid to minimize the trapped air pockets. In this example embodiment as shown in FIG. 1, an inlet 64 and an outlet 64′ are respectively provided at the covers 16 and 16′ so as to keep the fluid being filled in the device in one direction, which will help solve this problem.

In a preferable embodiment, an inlet is configured to connect a directional valve. In another embodiment, a directional valve is fit to the housing 14 as an inlet, which is readily understood for one of ordinary skill in the art.

The directional valve that is used in the invention can be any of those well-known to ordinary skill in the art.

An exemplary MR fluid filling setup including a hand pump (for example, ENERPAC® P-142), two pressure gauges, two quick-release couplers (for example, FASTER® ANV 14 GAS), etc. is used in the invention to pressurize the fluid chamber in order to prevent the force-lag phenomenon of the MR damper. The MR fluid will be pumped into the MR damper by using the hand pump. One pressure gauge is used to monitor the outlet pressure of the hand pump, and the other pressure gauge is used to monitor the internal pressure of the MR damper. The quick couplers are used in a hydraulic system to quickly connect lines without losing fluids or fluid pressure. The quick coupler consists of two mating halves: the plug (male) half and the coupler (female) half. The female coupler itself acts as a directional valve, which can withstand a working pressure as high as 5,000 psi.

An MR fluid 48 is first introduced into the MR damper 10 via the inlet/outlet 64 or 64′ through a passageway 66 or 66′ to the compartment 22. When the compartment 22 is fully filled with the MR fluid 48, a hydraulic directional valve 68 and a hydraulic fastener 70 are fastened to the inlet/outlet 64, 64′ respectively or vice versa. In order to minimize the trapped air pockets inside the MR damper 10, the MR damper 10 is pre-run for several cycles and kept stable for several hours. Then the MR fluid filling process as aforementioned is repeated until no more refills can be done. The above can help minimize the air pocket inside the MR damper. Finally, the compartment 22 of the MR damper 10 is pressurized in order to prevent the force-lag effect by pressuring the MR fluid in the MR damper 10 via the directional valve 68. The use of the directional valve 68 provides a compact and alternate solution to the use of an accumulator to solve the force-lag effect.

The MR damper according to the present invention is broadly applied to the vibration reduction system, in particular to a railway vehicle suspension system. The MR damper 10 can be used to replace conventional dampers to provide an excellent performance in the railway suspension system. In practice, the MR damper body is attached to a first structure of the railway vehicle (says the truck) through the covers 16 and 16′ or the tie rod 20 or 20′. Then the at least one end of the piston rods 30 and 30′ is attached to a second structure of the railway vehicle (says the car body) through the at least one end of the threaded rod ends 46 and 46′. The controller 72 may be used to control the MR damper 10 via controlling an input current according to the information from the sensor 74.

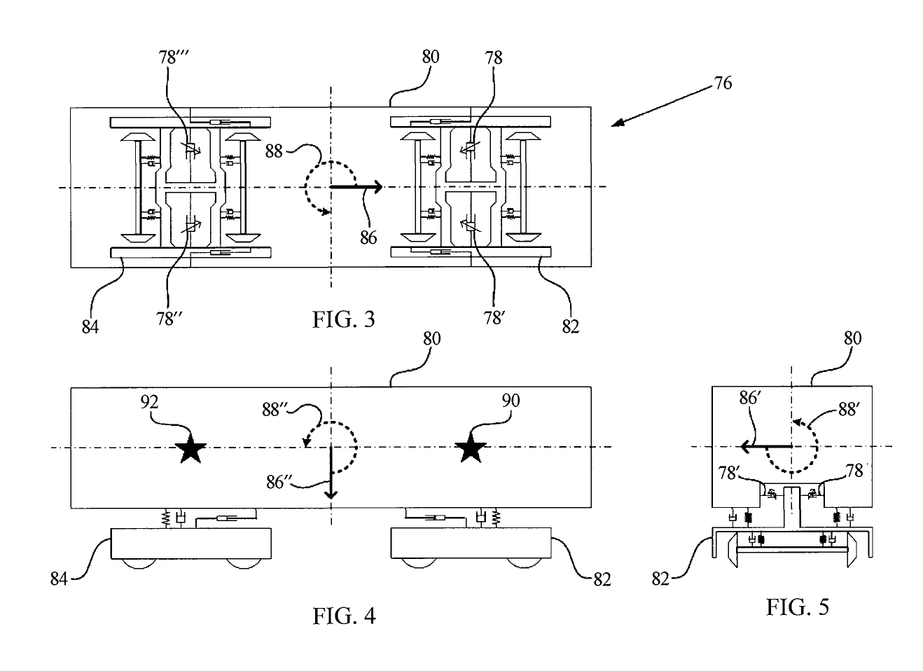

FIGS. 3, 4 and 5 illustrate a railway vehicle 76 utilizing MR dampers 78, 78′, 78″ and 78′″, according to an example embodiment of the present invention.

MR dampers 78 and 78′ are attached in a secondary suspension system between the car body 80 and leading truck 82. MR dampers 78″ and 78′″ are attached in the secondary suspension system between the car body 80 and trailing truck 84. Numerals 86, 86′ and 86″ represent the longitudinal (x), lateral (y), vertical (z) directions of the railway vehicle, respectively; and numerals 88, 88′ and 88″ represent the yaw, roll, and pitch directions of the railway vehicle, respectively.

A control strategy adopted based on the measurement of the absolute lateral velocity of the car body and compared with a predetermined threshold velocity can be found in “Semi-Active Suspension Improves Rail Vehicle Ride” by O'Neill and Wale. In this embodiment of the present invention, the absolute lateral velocities of a car body center 90 above the leading truck 82 and a car body center 92 above the trailing truck 84 will be measured individually by different sensors. Then, the damping forces of those two sets of the MR dampers 78, 78′ and 78″, 78′″ will be controlled individually according to the comparison of the measurement of each sensor with the predetermined threshold velocity.

Although the above example embodiments of the present invention have been described herein for illustrative purpose, one of ordinary skill in the art will appreciate that various modifications, additions and substitutions, without departing from the spirit of the invention can be made, which will fall within the scope of the appended claims.

1. A magnetorheological fluid device, comprising:
a) a housing including a hollow;
b) a moving mechanism within the hollow, the housing and the moving mechanism positioned to define at least one working portion and at least one chamber within the hollow;
c) a magnetorheological fluid (MR fluid) within the at least one working portion and the chamber, wherein the MR fluid has a pressure of at least 100 psi; and
d) a magnetic field generator that generates a magnetic field to act upon the MR fluid within the working portion to cause a rheology change therein.

2. The device of claim 1 further including a fluid inlet and a fluid outlet.

3. The device of claim 2, wherein said fluid inlet comprises a directional valve.

4. The device of claim 3, wherein the device is a damper including at least one piston rod extended out of the housing, and the moving mechanism is a piston assembly which comprises:
a piston head sleeve attached around the piston rod; and
at least one cushion ring attached to the piston rod and axially extended along the piston rod from the piston head sleeve.

5. The device of claim 4, wherein the cushion ring is configured to reduce resistance between the piston assembly and the MR fluid while the damper operates.

6. The device of claim 5, wherein the device comprises two piston rods having the same diameter.

7. The device of claim 1, wherein the pressure is in the range of 100 psi to 400 psi.

8. The device of claim 2, wherein the pressure is in the range of 100 psi to 400 psi.

9. The device of claim 8, wherein the pressure is in the range of 100 psi to 200 psi.

10. A method for minimizing cavitation of a magnetorheological device, comprising: pressurizing a magnetorheological fluid (MR fluid) within the device with a pressure of at least 100 psi.

11. The method of claim 10, wherein the pressure is in the range of 100 psi to 400 psi.

12. The method of claim 10, wherein the magnetorheological device is a magnetorheological damper providing an inlet and an outlet, and wherein the MR fluid is provided through a directional valve connected to the inlet.

13. The method of claim 12, wherein the method further comprises pre-running the magnetorheological damper so that no more refills can be filled in the damper, before the pressurizing is performed.

14. A suspension system of a railway vehicle comprising at least one magnetorheological damper arranged between a truck and a car body of the railway vehicle, wherein the magnetorheological damper comprises:
a) a housing including a hollow;
b) a moving mechanism within the hollow, the housing and the moving mechanism positioned to define at least one working portion and at least one chamber within the hollow;
c) a magnetorheological fluid (MR fluid) within the at least one working portion and the chamber, wherein the MR fluid has a pressure of at least 100 psi; and
d) a magnetic field generator that generates a magnetic field to act upon the MR fluid within the working portion to cause a rheology change therein.

15. The suspension system of claim 14, further comprising at least one sensor mounted to the truck or the car body, and a controller to process a signal from the sensor and to control the damper operation in accordance therewith.
